(19) United States
(12) Patent Application Publication
(10) Pub. No.: US 2025/0209677 A1
(43) Pub. Date: Jun. 26, 2025

(54) DECODING METHOD

(71) Applicant: Panasonic Intellectual Property Corporation of America, Torrance, CA (US)

(72) Inventors: Atsushi Ito, Osaka (JP); Takahiro Nishi, Nara (JP); Noritaka Iguchi, Osaka (JP); Toshiyasu Sugio, Osaka (JP)

(21) Appl. No.: 19/078,909

(22) Filed: Mar. 13, 2025

Related U.S. Application Data
(63) Continuation of application No. PCT/JP2023/032696, filed on Sep. 7, 2023.
(60) Provisional application No. 63/408,273, filed on Sep. 20, 2022.

(51) Int. Cl. G06T 9/40

(52) U.S. Cl. CPC G06T 9/40

(57) ABSTRACT

A decoding method includes: receiving encoded information relating to three-dimensional points; and determining, based on the encoded information, whether to specify a curved surface with which the three-dimensional points are to be approximated.

### CROSS REFERENCE TO RELATED APPLICATIONS

This application is a U.S. continuation application of PCT International Patent Application Number PCT/JP2023/032696 filed on Sep. 7, 2023, claiming the benefit of priority of U.S. Provisional Patent Application No. 63/408,273 filed on Sep. 20, 2022, the entire contents of which are hereby incorporated by reference.

### FIELD

The present disclosure relates to decoding methods and decoding devices.

### BACKGROUND

Devices or services utilizing three-dimensional data are expected to find their widespread use in a wide range of fields, such as computer vision that enables autonomous operations of cars or robots, map information, monitoring, infrastructure inspection, and video distribution. Three-dimensional data is obtained through various means including a distance sensor such as a rangefinder, as well as a stereo camera and a combination of a plurality of monocular cameras.

Methods of representing three-dimensional data include a method known as a point cloud scheme that represents the shape of a three-dimensional structure by a point cloud in a three-dimensional space. In the point cloud scheme, the positions and colors of a point cloud are stored. While point cloud is expected to be a mainstream method of representing three-dimensional data, a massive amount of data of a point cloud necessitates compression of the amount of three-dimensional data by encoding for accumulation and transmission, as in the case of a two-dimensional moving picture (examples include Moving Picture Experts Group-4 Advanced Video Coding (MPEG-4 AVC) and High Efficiency Video Coding (HEVC) standardized by MPEG).

Meanwhile, point cloud compression is partially supported by, for example, an open-source library (Point Cloud Library) for point cloud-related processing.

Furthermore, a technique for searching for and displaying a facility located in the surroundings of the vehicle by using three-dimensional map data is known (see, for example, Patent Literature (PTL) 1).

### CITATION LIST

### Patent Literature

PTL 1: International Publication WO 2014/020663

### SUMMARY

### Technical Problem

Furthermore, as an encoding scheme, there are cases where an irreversible compression scheme is used. In such a case, a decoded point cloud does not perfectly match the original point cloud. Therefore, there is a demand to be able to improve reproducibility of the point cloud to be decoded.

The present disclosure provides decoding methods or decoding devices that are capable of improving reproducibility of a point cloud to be decoded.

### Solution to Problem

A decoding method according to an aspect of the present disclosure includes: receiving encoded information relating to three-dimensional points; and determining, based on the encoded information, whether to specify a curved surface with which the three-dimensional points are to be approximated.

A decoding method according to an aspect of the present disclosure includes: specifying a plane based on encoded information included in a bitstream; and generating at least one three-dimensional point away from the plane.

A decoding method according to an aspect of the present disclosure includes: moving a first vertex away from a center of gravity of second vertexes, the first vertex and the second vertexes being included among vertexes specified based on encoded information included in a bitstream; specifying a plane or a curved surface by using the first vertex moved and the second vertexes; and generating three-dimensional points on the plane or the curved surface.

### Advantageous Effects

The present disclosure provides decoding methods or decoding devices that are capable of improving reproducibility of a point cloud to be decoded.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating an example of an original point cloud according to an embodiment.

FIG. 2 is a diagram illustrating an example of a trimmed octree according to the embodiment.

FIG. 3 is a diagram illustrating an example in which a leaf-node according to the embodiment is two-dimensionally displayed.

FIG. 4 is a diagram for describing a method for generating a centroid vertex according to the embodiment.

FIG. 5 is a diagram for describing the method for generating a centroid vertex according to the embodiment.

FIG. 6 is a diagram illustrating an example of vertex information according to the embodiment.

FIG. 7 is a diagram illustrating an example of a TriSoup surface according to the embodiment.

FIG. 8 is a diagram for describing point cloud reconstruction processing according to the embodiment.

FIG. 9 is a diagram illustrating an example of an original point cloud and a reconstructed point cloud according to the embodiment.

FIG. 10 is a diagram illustrating an example of vertexes and a triangle according to the embodiment.

FIG. 11 is a diagram illustrating an example of vertexes and a triangle according to the embodiment.

FIG. 12 is a diagram illustrating an example of vertexes and a triangle according to the embodiment.

FIG. 13 is a diagram illustrating an example of vertexes and a triangle according to the embodiment.

FIG. 14 is a diagram illustrating an example of curved surface determining method according to the embodiment.

FIG. 15 is a diagram illustrating an example of a point cloud according to the embodiment.

FIG. 16 is a flowchart of decoding processing according to the embodiment.

FIG. 17 is a flowchart of reconstructed point generation processing according to the embodiment.

FIG. 18 is a diagram illustrating an example of a centroid vector according to the embodiment.

FIG. 19 is a diagram illustrating an example of a common edge vertex according to the embodiment.

FIG. 20 is a diagram illustrating an example of an original point cloud and an ordinary (non-adjusted) reconstructed point according to the embodiment.

FIG. 21 is a diagram illustrating an example of the reconstructed point after adjustment according to the embodiment.

FIG. 22 is a diagram illustrating an example of an original point cloud and an ordinary reconstructed point according to the embodiment.

FIG. 23 is a diagram illustrating an example of the reconstructed point after adjustment according to the embodiment.

FIG. 24 is a flowchart of decoding processing according to the embodiment.

FIG. 25 is a block diagram of a decoding device according to the embodiment.

FIG. 26 is a flowchart of encoding processing according to the embodiment.

FIG. 27 is a block diagram of an encoding device according to the embodiment.

### DESCRIPTION OF EMBODIMENTS

A decoding method according to an aspect of the present disclosure includes: receiving encoded information relating to three-dimensional points; and determining, based on the encoded information, whether to specify a curved surface with which the three-dimensional points are to be approximated. Accordingly, with the decoding method, for example, when reproducibility of the original point cloud can be improved by specifying a curved surface with which the three-dimensional points are to be approximated, the curved surface can be specified. Therefore, the decoding method can improve the reproducibility of the original point cloud.

For example, in the determining, whether to specify the curved surface with which the three-dimensional points are to be approximated or to specify a plane with which the three-dimensional points are to be approximated may be determined. Accordingly, with the decoding method, for example, when reproducibility of the original point cloud cannot be improved by specifying a curved surface with which the three-dimensional points are to be approximated, or when reproducibility of the original point cloud can be improved by specifying a plane with which the three-dimensional points are to be approximated, the plane can be specified. Therefore, since the decoding method can specify the curved surface or the plane in accordance with the original point cloud, the decoding method can improve the reproducibility of the original point cloud.

For example, the curved surface or the plane may be provided within a first node of an octree structure of the three-dimensional points. Accordingly, with the decoding method, for example, the curved surface or the plane can be specified on a per node basis, and thus processing can be appropriately selected according to the properties of the node.

For example, the plane may be specified according to a TriSoup scheme or a mesh scheme. Accordingly, since the original point cloud can be approximated with a curved surface without the restriction of only being able to approximate the original point cloud with a plane, such as in a conventional TriSoup scheme or mesh scheme, there are cases where reproducibility of the original point cloud can be improved.

For example, the curved surface may protrude from the plane, away from a center of gravity of edge vertexes, the edge vertexes specifying the plane according to the TriSoup scheme.

For example, the curved surface may be specified according to information included in the encoded information, the information specifying the plane according to the TriSoup scheme.

For example, an amount of protrusion of the curved surface may be greater as the plane is larger. Accordingly, with the decoding method, a curved surface that can improve the reproducibility of the shape of the original point cloud can be specified.

For example, an amount of protrusion at a central portion of the curved surface may be greater than an amount of protrusion at a peripheral portion of the curved surface. Accordingly, with the decoding method, a curved surface that can improve the reproducibility of the shape of the original point cloud can be specified.

For example, whether to specify the curved surface may be determined based on at least two feature points within a first node of an octree structure of the three-dimensional points, and the at least two feature points may be derived from the encoded information. Accordingly, with the decoding method, whether to specify the curved surface can be determined using information derived from the encoded information.

For example, the at least two feature points may be selected from a centroid vertex and a center of gravity of edge vertexes, and the edge vertexes and the centroid vertex may be derived according to a TriSoup scheme.

A decoding method according to an aspect of the present disclosure includes: specifying a plane based on encoded information included in a bitstream; and generating at least one three-dimensional point away from the plane. Accordingly, with the decoding method, for example, reproducibility of the original point cloud can be improved compared to when a point is generated only on a plane. For example, it is possible to improve the reproducibility of a curved surface shape which has poor reproducibility using a plane.

For example, the plane may be specified according to a TriSoup scheme. For example, the plane and the at least one three-dimensional point may be located within a first node of an octree structure of three-dimensional points. Accordingly, with the decoding method, for example, processing can be performed appropriately according to the properties of the node.

For example, the plane may be located between the at least one 3D point and a center of gravity of edge vertexes, the edge vertexes specifying the plane according to the TriSoup scheme. Accordingly, reproducibility of the protrusion, and so on, of the original point cloud can be improved by the at least one three-dimensional point. For example, the plane may be specified according to a mesh scheme.

A decoding method according to an aspect of the present disclosure includes: moving a first vertex away from a center of gravity of second vertexes, the first vertex and the second vertexes being included among vertexes specified based on encoded information included in a bitstream; specifying a plane or a curved surface by using the first vertex moved and the second vertexes; and generating three-dimensional points on the plane or the curved surface. Accordingly, with the decoding method, by moving the vertex, for example, reproducibility of the protrusion, and so on, of the original point cloud can be improved.

A decoding device according to an aspect of the present disclosure includes: a processor; and memory. Using the memory, the processor: receives encoded information relating to three-dimensional points; and determines, based on the encoded information, whether to specify a curved surface with which the three-dimensional points are to be approximated.

A decoding device according to an aspect of the present disclosure includes: a processor; and memory. Using the memory, the processor: specifies a plane based on encoded information included in a bitstream; and generates at least one three-dimensional point away far from the plane.

A decoding device according to an aspect of the present disclosure includes: a processor; and memory. Using the memory, the processor: moves a first vertex away from a center of gravity of second vertexes, the first vertex and the second vertexes being included among vertexes specified based on encoded information included in a bitstream; specifies a plane or a curved surface by using the first vertex moved and the second vertexes; and generates three-dimensional points on the plane or the curved surface.

It is to be noted that these general or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

Hereinafter, embodiments will be specifically described with reference to the drawings. It is to be noted that each of the following embodiments indicate a specific example of the present disclosure. The numerical values, shapes, materials, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

### Embodiment

Hereinafter, an encoding device (three-dimensional data encoding device) and a decoding device (three-dimensional data decoding device) according to the present embodiment will be described. The encoding device encodes three-dimensional data to thereby generate a bitstream. The decoding device decodes the bitstream to thereby generate three-dimensional data.

Three-dimensional data is, for example, three-dimensional point cloud data (also called point cloud data). A point cloud, which is a set of three-dimensional points, represents the three-dimensional shape of an object. The point cloud data includes position information and attribute information on the three-dimensional points. The position information indicates the three-dimensional position of each three-dimensional point. It should be noted that position information may also be called geometry information. For example, the position information is represented using an orthogonal coordinate system or a polar coordinate system.

Attribute information indicates color information, reflectance, infrared information, a normal vector, or time-of-day information, for example. One three-dimensional point may have a single item of attribute information or have a plurality of kinds of attribute information.

It should be noted that although mainly the encoding and decoding of position information will be described below, the encoding device may perform encoding and decoding of attribute information.

### [TriSoup Scheme]

The encoding device according to the present embodiment encodes position information by using a Triangle-Soup (TriSoup) scheme.

The TriSoup scheme is an irreversible compression scheme for encoding position information on point cloud data. In the TriSoup scheme, an original point cloud being processed is replaced by a set of triangles, and the point cloud is approximated on the planes of the triangles. Specifically, the original point cloud is replaced by vertex information on vertexes within each node, and the vertexes are connected with each other to form a group of triangles. Furthermore, the vertex information for generating the triangles is stored in a bitstream, which is sent to the decoding device.

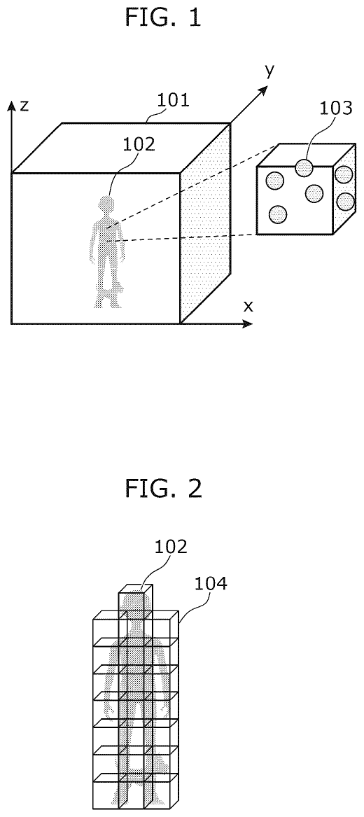

Now, encoding processing using the TriSoup scheme will be described. FIG. 1 is a diagram illustrating an example of an original point cloud. As shown in FIG. 1, point cloud 102 of an object is in target space 101 and includes points 103.

First, the encoding device divides the original point cloud into an octree up to a predetermined depth. In octree division, a target space is divided into eight nodes (subspaces), and 8-bit information (an occupancy code) indicating whether each node includes a point cloud is generated. A node that includes a point cloud is further divided into eight nodes, and 8-bit information indicating whether these eight nodes each include a point cloud is generated. This processing is repeated up to a predetermined layer.

Here, typical octree encoding divides nodes until the number of point clouds in each node reaches, for example, one or a threshold. In contrast, the TriSoup scheme performs octree division up to a layer along the way and not for layers lower than that layer. Such an octree up to a midway layer is called a trimmed octree.

FIG. 2 is a diagram illustrating an example of a trimmed octree. As shown in FIG. 2, point cloud 102 is divided into leaf-nodes 104 (lowest-layer nodes) of a trimmed octree.

The encoding device then performs the following processing for each leaf-node 104 of the trimmed octree. It should be noted that a leaf-node may hereinafter also be simply referred to as a node.

The encoding device generates vertexes on edges of the node as representative points of the point cloud near the edges. These vertexes are called edge vertexes. For example, an edge vertex is generated on each of a plurality of edges (for example, four parallel edges).

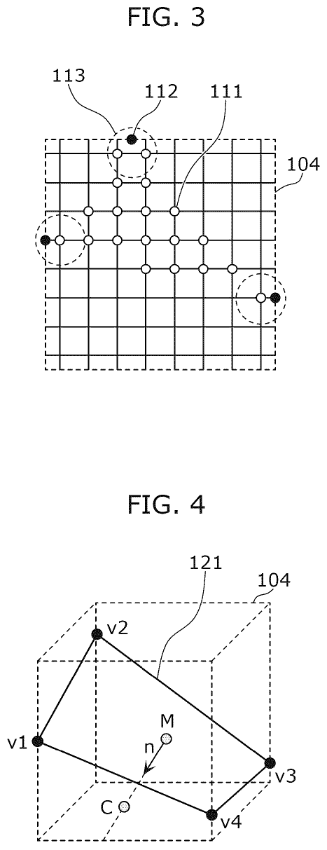

FIG. 3 is a diagram illustrating an example of two-dimensional display of leaf-node 104, for example, the xy-plane viewed along the z-direction shown in FIG. 1. As shown in FIG. 3, edge vertexes 112 are generated on edges based on points near the edges, among points 111 within leaf-node 104.

It should be noted that the dotted lines in FIG. 3 along the perimeter of leaf-node 104 represent the edges. Also in this example, each edge vertex 112 is generated at a weighted average of the positions of points within the distance 1 from the corresponding edge (points within each range 113 in FIG. 3). It should be noted that the unit of distance may be, by way of example and not limitation, the resolution of the point cloud. Although the distance (the threshold) is 1 in this example, the distance may be a value other than 1 or may be variable.

The encoding device then generates a vertex inside the node as well, based on a point cloud located in the direction of the normal to the plane that includes edge vertexes. This vertex is called a centroid vertex.

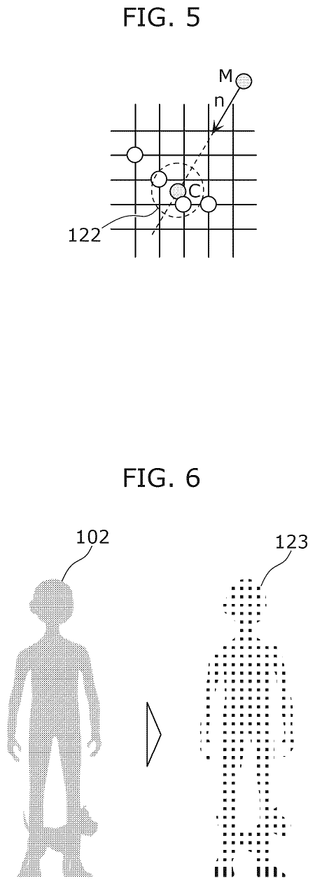

FIGS. 4 and 5 are diagrams for describing a method for generating the centroid vertex. First, the encoding device selects, for example, four points as representative points from a group of edge vertexes. In the example shown in FIG. 4, edge vertexes v1 to v4 are selected. The encoding device then calculates approximate plane 121 passing through the four points. The encoding device then calculates normal n to approximate plane 121 and average coordinates M of the four points. The encoding device then generates centroid vertex C at weighted-average coordinates of one or more points near a half line extending along normal n from average coordinates M (e.g., points within range 122 shown in FIG. 5).

The encoding device then entropy-encodes vertex information, which is information on the edge vertexes and the centroid vertex, and stores the encoded vertex information in a geometry data unit (hereinafter referred to as a GDU) included in the bitstream. It should be noted that, in addition to the vertex information, the GDU includes information indicating the trimmed octree.

FIG. 6 is a diagram illustrating an example of the vertex information. The above processing transforms point cloud 102 into vertex information 123, as shown in FIG. 6.

Now, decoding processing for the bitstream generated as above will be described. First, the decoding device decodes the GDU from the bitstream to obtain the vertex information. The decoding device then connects the vertexes to generate a TriSoup surface, which is a group of triangles.

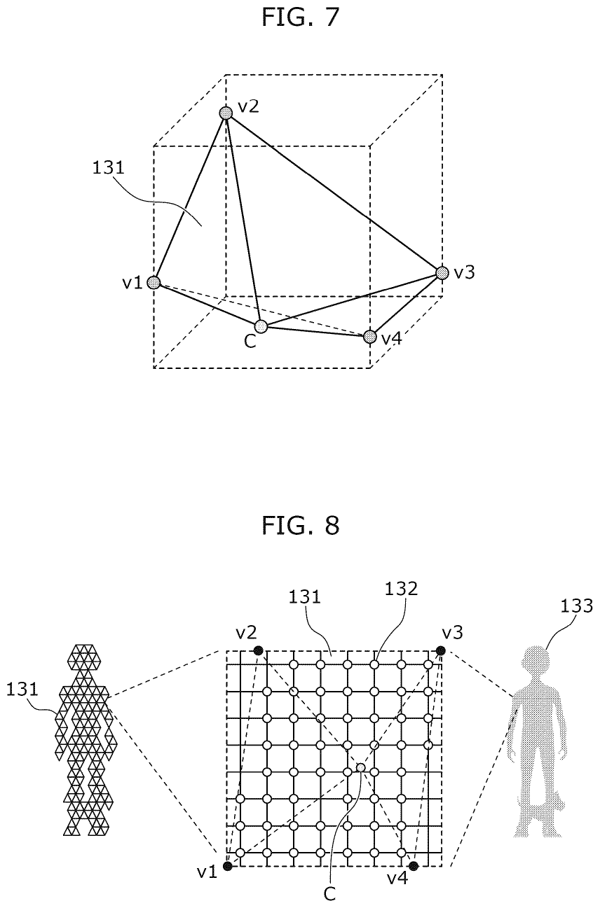

FIG. 7 is a diagram illustrating an example of the TriSoup surface. In the example shown in FIG. 7, four edge vertexes v1 to v4 and centroid vertex C are generated based on the vertex information. Furthermore, triangles 131 (a TriSoup surface) are generated, each having centroid vertex C and two edge vertexes as its vertexes. For example, a pair of two edge vertexes on a pair of two adjacent edges is selected to form triangle 131 having the selected pair of edge vertexes and the centroid vertex as its vertexes.

FIG. 8 is a diagram for describing point cloud reconstruction processing. The above processing is performed for each leaf-node to generate a three-dimensional model that represents the object with triangles 131, as shown in FIG. 8.

The decoding device then generates points 132 at regular intervals on the surface of triangles 131 to reconstruct the position information on point cloud 133.

### [Curved Surface Reconstruction Processing]

For example, in a technique for approximating a point cloud with a plane, such as a TriSoup technique, the encoding device samples an original point cloud (a point cloud to be encoded) using vertexes and transmits information on the vertexes to a decoding device. The decoding device connects the vertexes to reconstruct a surface. Due to the nature of such processing, for example, the reconstruction of a triangle surface from points by the TriSoup technique unfortunately fails to reproduce a protrusion of a convex surface or a depression of a concave surface not larger than the granularity of the size of the triangle even if there is a protrusion or a depression.

In contrast, in the present embodiment, the decoding device generates a triangle (a TriSoup surface) using, for example, the TriSoup technique. When generating points on the triangle using ray tracing, the decoding device generates the points in accordance with the result of determining a protrusion side of a convex surface or a depression side of a concave surface.

For example, the decoding device determines an opposite side to a side on which the center of gravity of edge vertexes as seen from the triangle, as a “side on which a protrusion or a depression is present” (a reconstructed surface) and generates a reconstructed point at a position at an offset from the triangle surface.

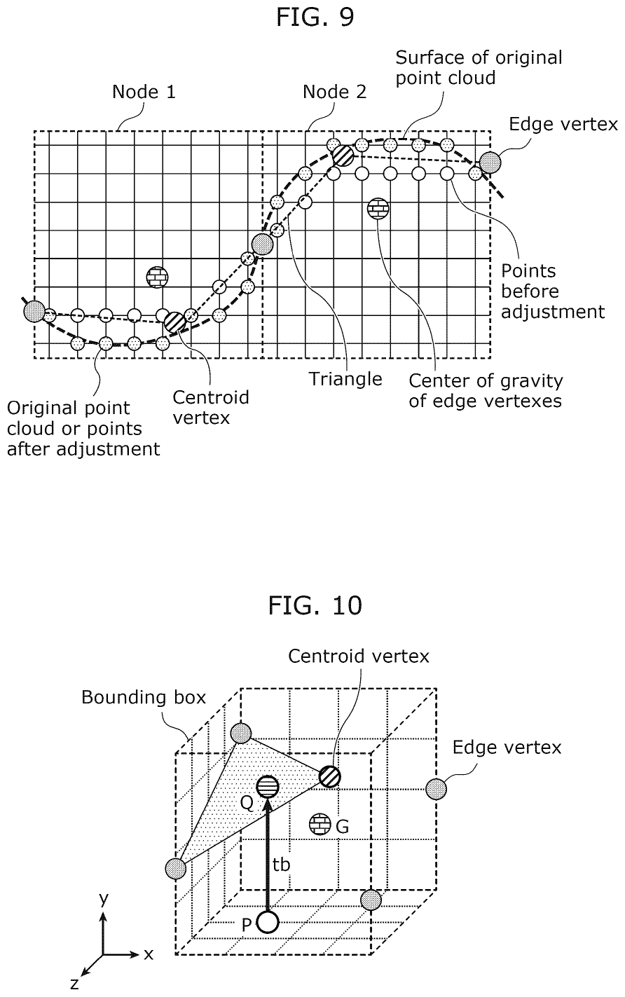

FIG. 9 is a diagram illustrating an overview of this processing, and illustrating an example of original point clouds and reconstructed point clouds in node 1 and node 2. It should be noted that FIG. 9 illustrates an example in which adjacent node 1 and node 2 are two-dimensionally displayed. In the example illustrated in FIG. 9, node 1 includes a concave surface (the surface of an original point cloud) and node 2 includes a convex surface. In this case, by shifting a reconstructed point cloud (points before adjustment that are generated by a normal ray tracing) away from the center of gravity of edge vertexes in each node, the original point cloud can be reproduced from the reconstructed point cloud.

Accordingly, the decoding device can reproduce a protrusion or a depression of the original point cloud with a small amount of calculation, without performing an iterative calculation for curved surface estimation or function fitting.

The above processing will be described below in detail. The decoding device first defines a bounding box of a triangle to generate points on or in the vicinity of the surface of the triangle. The decoding device extends vectors from sets of integer grid coordinates P on planes included in the bounding box in x-, y-, and z-axis directions and generates reconstructed points Q at intersections of the vectors and the triangle.

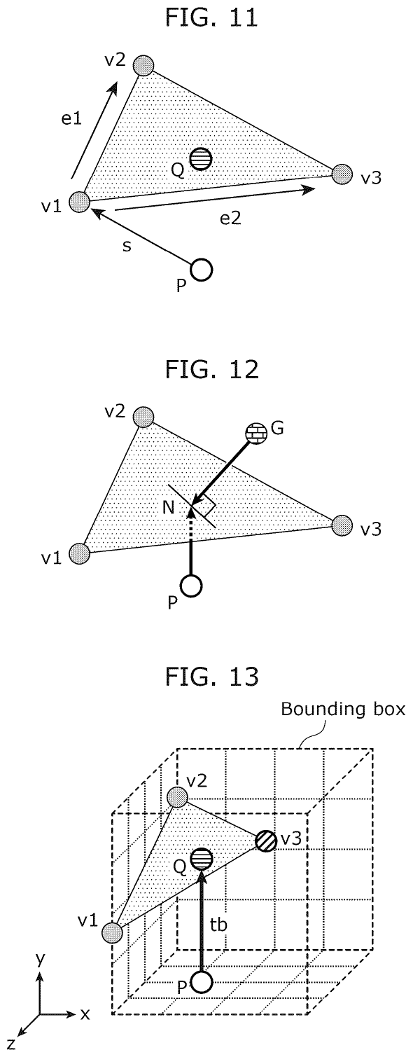

The Moller-Trumbore ray-triangle intersection algorithm, which is an example of this ray-tracing technique, will be described with reference to FIG. 10 and FIG. 11. FIG. 10 and FIG. 11 are diagrams each illustrating an example of vertexes and a triangle.

Emitting point P of a ray is provided at each set of integer grid coordinates on an yz-plane, an xz-plane, and an xy-plane included in a bounding box enclosing the triangle.

As an example, consider the case where the ray tracing is performed in three directions from an yz-plane, an xz-plane, and an xy-plane. b is a unit vector in any one of x, y, and z directions. u, v, and w are vector coefficients representing a triangle surface. In addition, the following formulas are established.

$$h = b \times e 2 \\ a = e 1 \cdot h \\ u = s \cdot h / a \\ q = s \times e 1 \\ v = b \cdot q / a \\ t = e 2 \cdot q / a$$

It should be noted that, as illustrated in FIG. 11, the triangle is formed by vertexes v1, v2, and v3. Vertexes v1, v2, and v3 are each an edge vertex or a centroid vertex. tb is a vector from emitting point P to reconstructed point Q, and t is the distance between emitting point P and reconstructed point Q. s is a vector from emitting point P to vertex v1, e1 is a vector from vertex v1 to vertex v2, and e2 is a vector from vertex v1 to vertex v3. From the above formulas, distance t is determined. Thus, the coordinates of reconstructed point Q are given by Q=P+tv.

Furthermore, in the present embodiment, a protrusion in the distribution of an original point cloud is reproduced by adjusting distance t. Here, in the ray tracing on the triangle, a reconstructed surface is present on a surface on the opposite side to center of gravity G of edge vertexes in all cases. Thus, the decoding device adjusts t such that reconstructed point Q indicates a surface on the opposite side of center of gravity G as seen from the triangle. Specifically, the decoding device calculates Δt to calculate a distance after the adjustment, t′=t+Δt. FIG. 12 is a diagram for describing this processing, and illustrating an example of vertexes and a triangle.

Here, the polarity of Δt, which is an amount of change in t, changes as follows in accordance with the position of emitting point P of the ray. As illustrated in FIG. 12, the foot of the perpendicular from center of gravity G to the triangle is denoted as N. In this case, the positional relationship among emitting point P of the ray, center of gravity G, and the triangle is determined in accordance with the inner product of vector GN and vector PN. Here, vector GN is a vector from the center of gravity G to foot N, and vector PN is a vector from the emitting point P to foot N.

When the inner product>0, emitting point P and center of gravity G are positioned on the same side of the surface of the triangle. When the inner product=0, emitting point P and center of gravity G are present on the triangle. When the inner product<0, emitting point P and center of gravity G are positioned on opposite sides of the surface of the triangle. Therefore, when the inner product>0, the decoding device sets a positive value to Δt, and when the inner product<0, the decoding device sets a negative value to Δt.

In the inner product=0, the decoding device does not perform the adjustment (set Δt as Δt=0). It should be noted that, when the absolute value of the inner product is less than a threshold value, the decoding device may determine the inner product as zero. Accordingly, it is possible to prevent or reduce malfunction. In addition, information indicating this threshold value may be transmitted from the encoding device to the decoding device. That is, the information indicating this threshold value may be included in the bitstream.

Next, a method for determining an amount of protrusion |Δt| will be described. FIG. 13 is a diagram illustrating an example of vertexes and a triangle. Based on the Moller-Trumbore ray-triangle intersection algorithm, the following formulas are established for three vertexes (v1, v2, v3) of the triangle and reconstructed point Q.

$$Q = w \times v 1 + u \times v 2 + v \times v 3 \\ 0 \leq w , u , v \\ u + v + w = 1$$

In addition, t′, which is t after the adjustment, is given by t′=t+Δt. The polarity of Δt can be determined by the above-mentioned method. An example of calculating the absolute value of Δt, |Δt|, will be described below.

The decoding device sets |Δt| of a point away from a vertex of a triangle to be large. Specifically, in the case where (i) the value of any one of u, v, and w is close to 1 or/and in the case where (ii) the values of u, v, and w are uneven, for example, the decoding device determines that reconstructed point Q is present at, or in the vicinity of, an end or edge of the triangle and brings |Δt| close to 0 (set a small value to |Δt|). On the other hand, in the case where the values of u, v, and w make no difference or in the case where u, v, and w are close to a predetermined value, the decoding device determines that point Q is present in the vicinity of the center of the triangle and set a large value to |Δt|.

In the case where reconstructed point Q is present neither at an end or an edge of the triangle nor in the vicinity of the center of the triangle but at a position midway between the end or the edge and the center, the decoding device may set |Δt| using a method such as linear interpolation or curve interpolation in accordance with the position of the reconstructed point.

In addition, the maximum value of |Δt| may be determined on the basis of the length of the longest side of the triangle. For example, the decoding device can determine the maximum width of the protrusion in accordance with the size of the triangle by setting the maximum value of Δt to be a value obtained by dividing the size (e.g., the length of the longest side) of the triangle by an integer equal to or greater than one. That is, Δtmax=length of longest side of triangle/8 may be used, where Δtmax is the maximum value of Δt. It should be noted that “8” is an adjustment coefficient, and a value other than “8” may be used.

In this case, Δt is calculated as Δt=(1−max(w, u, v))×Δtmax. Here, max(A, B, . . . ) is a function that returns the largest value of its arguments.

As seen from the above, the decoding device may make |Δt| larger with an increase in the length of the longest side of the triangle. That is, the decoding device may make |Δt| larger with an increase in the size of the triangle. In other words, the protrusion amount (the amount of protrusion) of a curved surface increases with an increase in the size of the plane surface of the triangle. In addition, a protrusion amount of the curved surface at a central portion of the curved surface is greater than a protrusion amount of the curved surface at a peripheral portion of the curved surface. However, the above formulas are merely an example. Another weighting scheme may be used.

The decoding device uses Δt to calculate t′ and uses t′ to calculate the coordinates of Q′ from Q′=P+t′v. The decoding device adds the reconstructed point to a position of which the coordinates are the coordinate values of Q′ rounded to integers. For example, the position of which the coordinates are rounded to integers is a position on an x-y-z integer grid.

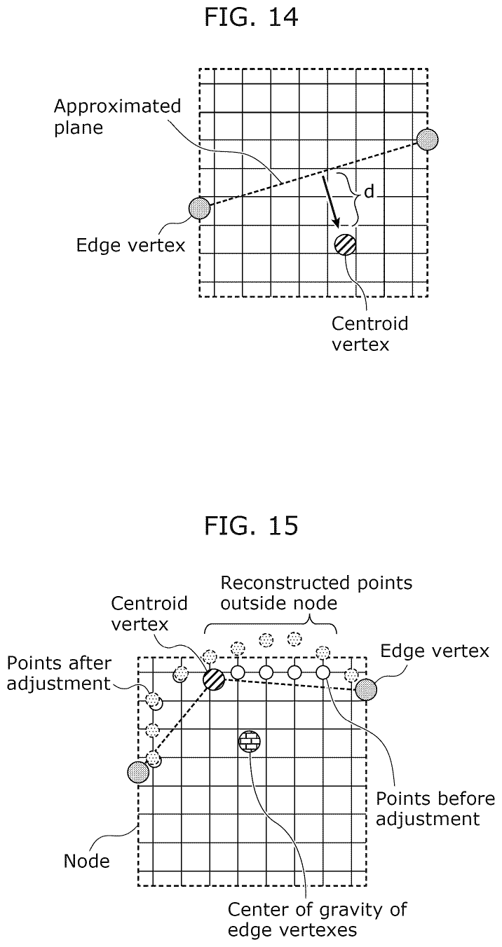

Next, a method for determining whether a curved surface is present will be described. FIG. 14 is a diagram illustrating an example of a curved surface determining method. The decoding device estimates an approximated plane from edge vertexes. The approximated plane is, for example, a plane including the edge vertexes. Next, the decoding device calculates offset amount d from the approximated plane and a centroid vertex. Here, offset amount d indicates the distance between the approximated plane and the centroid vertex.

When offset amount d is greater than a threshold value determined in advance, the decoding device determines that “a curved surface is present”. In this case, the decoding device performs curved-surface reconstruction processing (the adjustment of t) for reconstructing the above-mentioned protrusion. It should be noted that the decoding device may adjust the magnitude of Δtmax or Δt in accordance with offset amount d.

When offset amount d is less than or equal to the threshold value, the decoding device determines that “no curved surface is present” and does not perform the above-mentioned curved-surface reconstruction processing. That is, reconstructed points are generated on the plane. It should be noted that this determination is performed on a per node basis, for example.

It should be noted that the encoding device may calculate offset amount d and may store calculated offset amount d in the bitstream. In this case, the decoding device may perform the above processing using offset amount d included in the bitstream. In addition, the decoding device may determine that “no curved surface is present” when offset amount d is not included in the bitstream.

In addition, the decoding device may determine whether a curved surface that spans nodes from the distribution of edge vertexes in nodes is present, which will be described later.

In addition, the above threshold value for offset amount d may be transmitted from the encoding device to the decoding device. That is, the bitstream may include the threshold value.

In addition, vertexes in a node used for determining this approximated plane may be limited to edge vertexes or may include vertexes of another type.

In addition, the encoding device may instruct the decoding device whether the calculation of t′ for the expression of a convex or concave shape is needed (whether to perform the curved-surface reconstruction processing). For example, on the basis of the distribution state of an original point cloud, the encoding device determines whether the above-mentioned curved-surface reconstruction processing improves the accuracy of a reconstructed point cloud, and stores information indicating the result of the determination in the bitstream. For example, the information may be information indicating whether the decoding device is to perform the above-mentioned curved-surface reconstruction processing.

Furthermore, it is possible that the reconstructed point is located outside the frame of a node (leaf node) as a result of applying t′ determined by the above method. FIG. 15 is a diagram illustrating an example of a point cloud of this case. In this case, the decoding device may make correction such that reconstructed points located outside the node are located inside the node. Alternatively, the decoding device may in this case generate reconstructed points at positions before the above-mentioned curved-surface reconstruction processing is performed (positions before the adjustment).

### [Processing Flow]

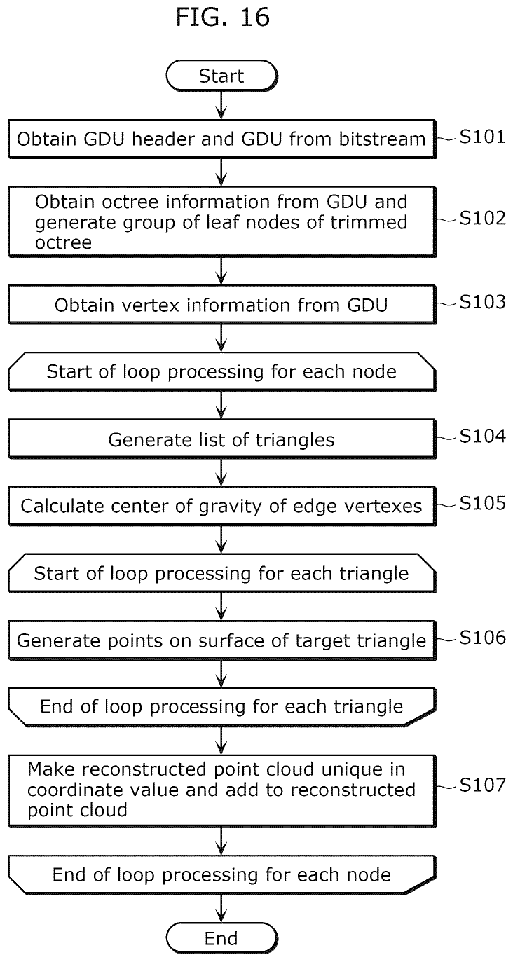

FIG. 16 is a flowchart of decoding processing by the decoding device according to the present embodiment. The decoding device first obtains a GDU header and a GDU from a bitstream (S101). The decoding device next obtains, from the GDU, octree information indicating a trimmed octree. For example, the decoding device obtains the octree information by entropy decoding encoded octree information included in the GDU. Using the octree information, the decoding device generates leaf nodes (a group of leaf nodes) of the trimmed octree (S102).

The decoding device next obtains, from the GDU, vertex information, which is position information on edge vertexes and a centroid vertex (S103). For example, the decoding device obtains the vertex information by entropy decoding encoded vertex information included in the GDU.

The decoding device next performs the processing of the following steps S104 to S107 (loop processing) on each of the leaf nodes of the trimmed octree. The decoding device first generates, for each combination of a centroid vertex and two of edge vertexes belonging to a target node, which is a leaf node being processed, a triangle that connects the centroid vertex and the two edge vertexes to thereby generate a list of triangles (S104). The decoding device next calculates center of gravity G of the edge vertexes of the target node (S105).

The decoding device next performs the processing of the following step S106 (loop processing) on each of the triangles included in the list of triangles. The decoding device generates points (reconstructed points) on a surface of a target triangle, which is a triangle being processed (S106). The loop processing on the target triangle is ended with the above.

The decoding device next makes the reconstructed points (reconstructed point cloud) in the target node unique in coordinate values and adds the unique reconstructed points to the reconstructed point cloud (S107). Here, making the reconstructed points unique is excluding points of which the sets of coordinate values are duplicated. The loop processing on the target node is ended with the above.

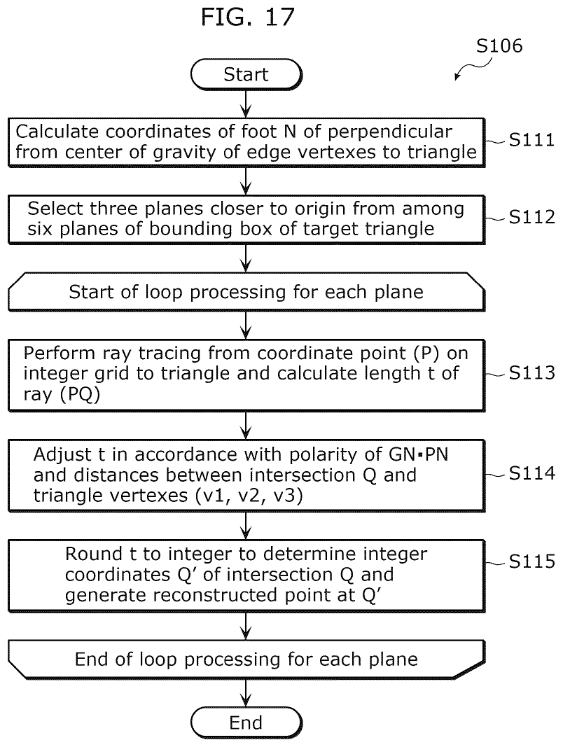

FIG. 17 is a flowchart illustrating reconstructed point generation processing (step S106 in FIG. 16) in detail. The processing illustrated in FIG. 17 is performed on a per triangle basis.

The decoding device first calculates the coordinates of foot N of the perpendicular from center of gravity G to the target triangle (S111). The decoding device next calculates a bounding box of the target triangle and selects three planes including an yz-plane, an xz-plane, and an xy-plane closer to an origin from among six planes forming the bounding box (S112).

The decoding device next performs the processing of the following steps S113 to S115 (loop processing) on each of the three planes of the bounding box. The decoding device first performs ray tracing from a coordinate point (emitting point P of a ray) on an integer grid on a target plane, which is a plane being processed, to the triangle to thereby calculate length t of the ray (PQ) (S113).

The decoding device next adjusts (increases or decreases) the value of t in accordance with the value of GN·PN (polarity), which is the inner product of vector GN and vector PN and the distances between intersection Q of the triangle and the ray (reconstructed point Q) and the vertexes of the triangle (v1, v2, v3) (S114). Specifically, as mentioned above, the decoding device determines the polarity of Δt in accordance with the polarity of GN·PN. In addition, the decoding device determines the absolute value of Δt in accordance with the distances between intersection Q and the vertexes of the triangle (v1, v2, v3). The decoding device calculates t′ by adjusting t using the determined Δt.

The decoding device rounds t after the adjustment (t′) to an integer to thereby calculate integer coordinates Q′ of intersection Q and adds Q′ as a reconstructed point to the reconstructed point cloud in the node. That is, the decoding device generates the reconstructed point to Q′ (S115). The loop processing on the target plane is ended with the above.

### [Variations]

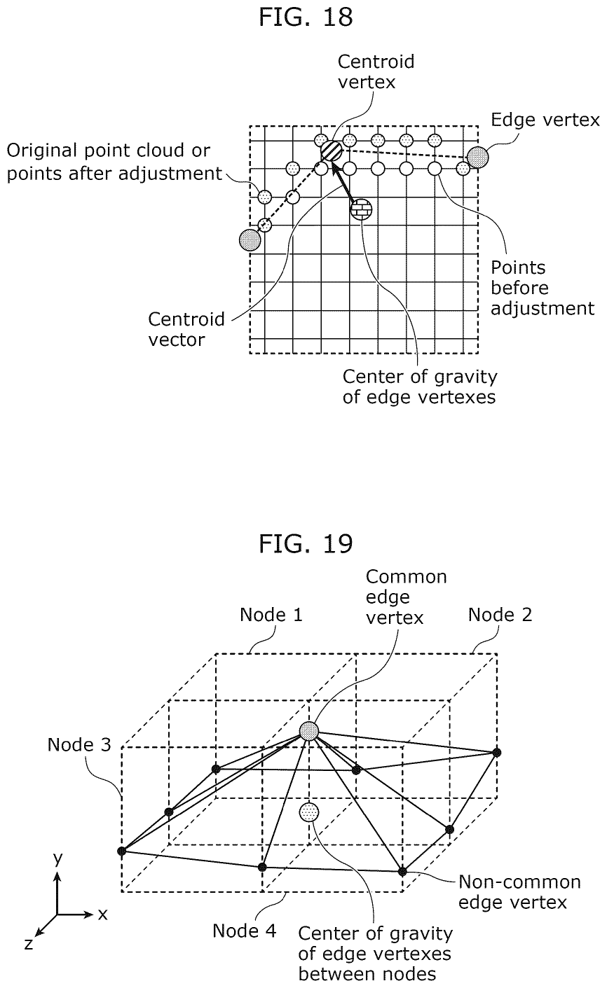

As a method for determining a reconstructed surface of a triangle, the method for determining a reconstructed surface of a triangle based on the center of gravity of edge vertexes has been described in the aforementioned example. However, the following method may be used. The decoding device may use, for the determination, the direction of the centroid vector from the center of gravity of the edge vertexes to a centroid vertex. FIG. 18 is a diagram illustrating an example of a centroid vector. In this case, the surface of a triangle located in the direction in which the centroid vector faces is determined as the reconstructed surface of points.

Furthermore, when the size of the centroid vector is greater than or equal to a threshold value determined in advance, the decoding device may perform the curved-surface reconstruction processing, which is position adjustment of the reconstructed point using aforementioned Δt, and when the size of the centroid vector is less than the threshold value, the decoding device need not perform the curved-surface reconstruction processing.

In addition, as another method, the decoding device may perform the determination using the position of a common edge vertex, which is an edge vertex common to adjacent nodes, rather than using the centroid vertex. FIG. 19 is a diagram illustrating an example of the common edge vertex.

In this scheme, the decoding device uses the common edge vertex as a temporary centroid vertex. In the example illustrated in FIG. 19, the common edge vertex is an edge vertex common to nodes 1 to 4. In addition, the decoding device calculates the center of gravity of non-common edge vertexes, which are edge vertexes other than the common edge vertex, (the center of gravity of the edge vertexes between the nodes) out of the edge vertexes in nodes 1 to 4. In other words, the non-common edge vertexes are edge vertexes that are not common to nodes 1 to 4.

Using the above common edge vertex as the centroid vertex and using the center of gravity of the edge vertexes between the nodes as the center of gravity of the edge vertexes, the decoding device can perform various types of determination and processing by the same method as the above-mentioned method. Accordingly, it is possible to determine whether a curved surface spanning nodes is present, determine a reconstructed surface on a per triangle basis, and calculate the amount of protrusion |Δt|, and thus the versatility of this technique improves.

It should be noted that although FIG. 19 illustrates a group of four nodes arranged on an xz-plane, this is merely an example. Alternatively, a group of adjacent nodes on an xy-plane or an yz-plane may be targeted in a scheme in which a common edge vertex is regarded as a temporary centroid vertex. In addition, the number of adjacent nodes is not limited to four. For example, similar processing may be performed on two nodes. In the case of two nodes, the number of common edge vertexes common to the nodes may be two. In this case, the center of gravity of edge vertexes in the nodes may be the center of gravity of edge vertexes excluding these two common edge vertexes.

In addition, as a method for transmitting information relating to the above processing, the following methods may be used. The bitstream may include a flag indicating whether the above-mentioned curved-surface reconstruction processing is to be turned ON or OFF (whether to perform the curved-surface reconstruction processing). When the flag indicates ON, the decoding device performs the curved-surface reconstruction processing, and when the flag indicates OFF, the decoding device does not perform the curved-surface reconstruction processing.

The encoding device stores the flag in SPS, GPS, or GDU, for example. SPS (Sequence Parameter Set) is metadata (a parameter set) that is common to a plurality of frames. GPS (Geometry Parameter Set) is metadata (parameter set) concerning encoding of position information. For example, GPS is metadata common to a plurality of frames.

In addition to or instead of the above flag, a flag indicating whether the curved-surface reconstruction processing is to be turned ON or OFF may be provided on a per node basis. Alternatively, the information about the curved-surface reconstruction processing may be transmitted in all cases, rather than the provision of the flag. Alternatively, in addition to the above flag, a flag for switching the above-mentioned various methods may be separately stored in the bitstream.

In addition, information indicating the maximum value of |Δt| or a parameter for determining the maximum value may be stored in the bitstream. In addition to the above, the aforementioned various parameters may be stored in the bitstream.

In addition, the above describes the technique for reproducing a protrusion of a surface of an original point cloud by adjusting the value of t when points are generated on a triangle by ray tracing, as a point cloud reconstruction technique in a TriSoup scheme. However, this approach is applicable to other techniques.

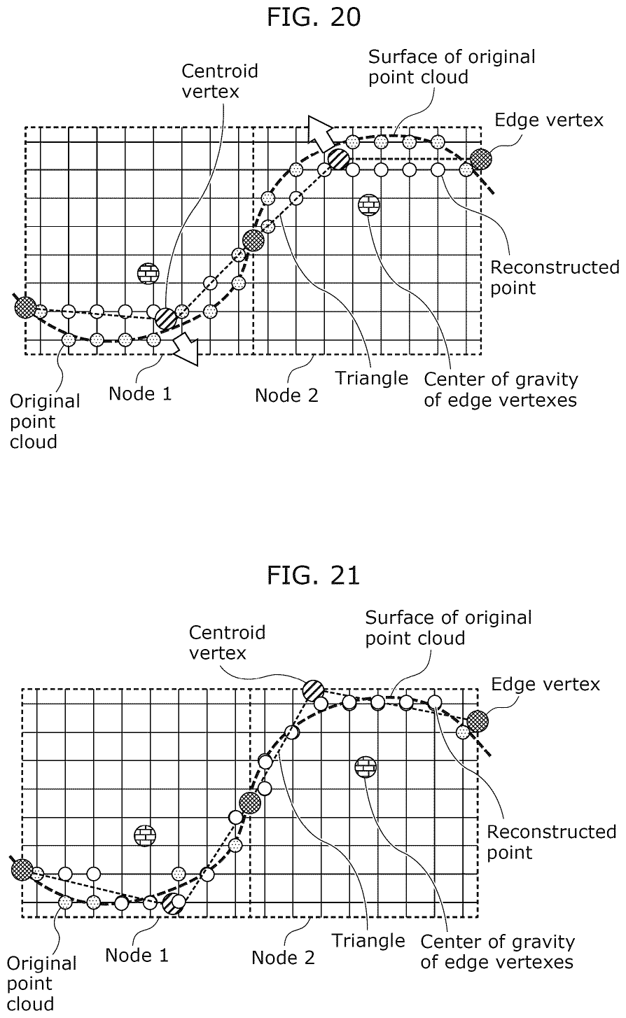

For example, a conceivable method in normal ray tracing without reconstruction of a protrusion is adjusting vertex positions to maintain the volume of a reconstructed point cloud. That is, the decoding device adjusts the vertex positions rather than adjusting the positions of points generated by ray tracing. Accordingly, the position of a triangle generated on the basis of the vertex positions after the adjustment is adjusted, and as a result, the positions of points generated by the ray tracing are also adjusted. FIG. 20 to FIG. 23 are diagrams for describing this method.

FIG. 20 is a diagram illustrating an example of an original point cloud and ordinary (non-adjusted) reconstructed points reconstructed by ray tracing. FIG. 21 is a diagram illustrating an example of reconstructed points after the adjustment. As illustrated in FIG. 21, the encoding device may move each centroid vertex illustrated in FIG. 20 in a direction away from the center of gravity of edge vertexes. Accordingly, as illustrated in FIG. 21, the reproducibility of the original point cloud can be improved.

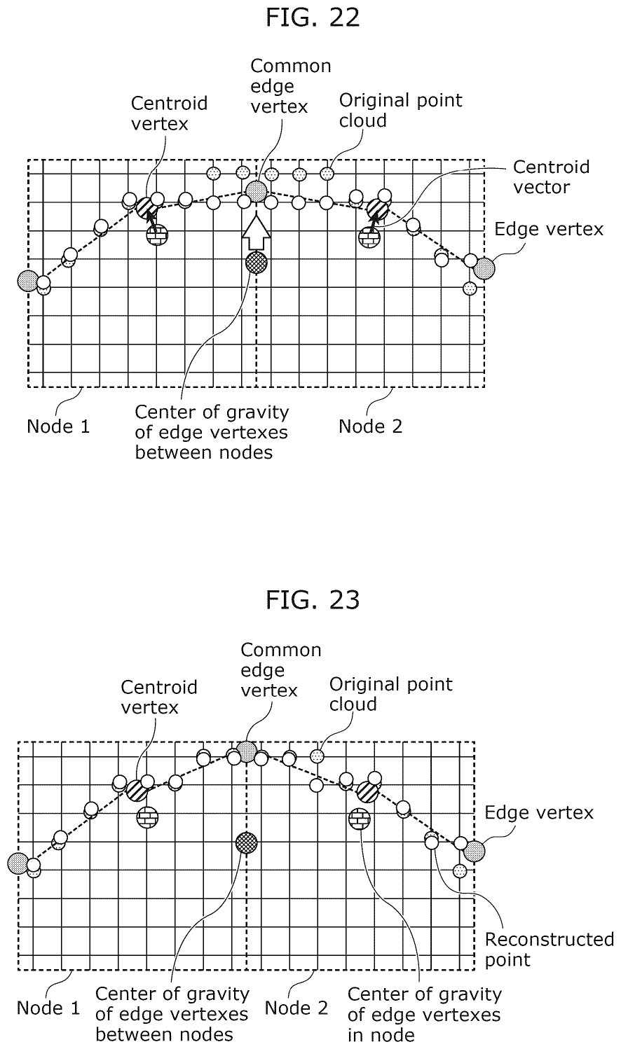

FIG. 22 is a diagram illustrating another example of an original point cloud and ordinary reconstructed points reconstructed by ray tracing. FIG. 23 is a diagram illustrating an example of reconstructed points after the adjustment. As illustrated in FIG. 23, the encoding device may move a common edge vertex in a direction away from the center of gravity of edge vertexes between nodes. That is, the encoding device may move the common edge vertex along an edge. It should be noted that, in this example, the common edge vertex is an edge vertex common to node 1 and node 2. In addition, the center of gravity of the edge vertex between nodes is the center of gravity of edge vertexes that are edge vertexes included in node 1 and node 2 except the common edge vertex. Accordingly, as illustrated in FIG. 23, the reproducibility of the original point cloud can be improved.

For example, the encoding device may move the common edge vertex when the directions of curved surfaces are the same between adjacent nodes (node 1 and node 2), and the encoding device need not move the common edge vertex when the directions are not the same. Here, the directions of the curved surfaces being the same refers to, for example, the case where the inner product of the centroid vector of node 1 and the centroid vector of node 2 has a positive value.

In addition, the amount of movement of each centroid vertex in the case illustrated in FIG. 20 and FIG. 21 may be determined, for example, to be proportional to a vertex-center-of-gravity distance that is the distance between the centroid vertex and the center of gravity of edge vertexes. That is, the amount of movement of the centroid vertex is set to be larger with an increase in the vertex-center-of-gravity distance.

In addition, the amount of movement of the common edge vertex in the case illustrated in FIG. 22 and FIG. 23 may be determined to be proportional to a vertex-center-of-gravity distance that is the distance between the common edge vertex and the center of gravity of edge vertexes between the nodes. That is, the amount of movement of the centroid vertex is set to be larger with an increase in the vertex-center-of-gravity distance.

For example, in both cases, the movement distance (amount of movement) of a vertex may be determined as movement distance of vertex=vertex-center-of-gravity distance×node width×⅛. It should be noted that “8” is an adjustment coefficient, and a value other than “8” may be used.

It should be noted that in the case where these vertex position adjustment methods are introduced into the scheme in which vertexes themselves are added as points to a reconstructed point cloud, the moved vertex positions may be positioned away from the original point cloud. Therefore, in such a case, the decoding device need not add the vertexes to the reconstructed point cloud.

In addition, the above technique for adjusting vertex positions can also be utilized in the case where mesh data is generated from a point cloud by the TriSoup scheme. The mesh data itself is in a form of expression. By gradually moving vertex positions given from an original point cloud by the TriSoup scheme in an outward direction of its volume before generating a polygon model, mesh data that maintains the volume of the original point cloud is obtained. It should be noted that the outward direction of the volume is a direction away from the center of a polyhedron defined by meshes.

In addition, at least part of the above-mentioned processing may be performed by an encoding device that rearranges one three-dimensional point. That is, the encoding device may adjust the position of a point (on a plane) after the rearrangement or may generate a rearranged point of which the position has adjusted to be on a curved surface.

### CONCLUSION

As described above, in the present embodiment, as a method for determining the presence of a curved surface, the decoding device determines whether a curved surface is present within a certain coordinate section. Furthermore, control information included in a bitstream includes a flag indicating whether the above-described function is to be turned ON or OFF. Furthermore, the control information may include a flag or information (parameter) for switching between the various methods described below.

For example, the control method may include at least one from among a flag indicating, for the entire point cloud, whether the above-described function is to be turned ON or OFF, a flag indicating, on a per node basis, whether the above-described function is to be turned ON or OFF, or information indicating a threshold value of a distance between two feature points for determining whether a curved surface is present.

Furthermore, the decoding device: estimates a reconstructed surface of a triangle according to a predetermined method when the curved surface is determined to be present, and generates a point at a position away from the estimated reconstructed surface. For example, the decoding device determines whether a curved surface is present by using the positional relationship between two feature points within a leaf node. For example, the two feature points are a centroid vertex and the center of gravity of edge vertexes. For example, the decoding device determines whether a curved surface is present, based on whether the distance between the two feature points within the leaf node is greater than or equal to the threshold value. It should be noted that the two feature points may be a common edge vertex between adjacent leaf nodes and the center of gravity of non-common edge vertexes.

Furthermore, the predetermined method may be a method for determining a reconstructed surface based on positions of feature points within a leaf node.

As a method for estimating a reconstructed surface, for example, the decoding device may determine, as the reconstructed surface, a surface on the opposite side of the center of gravity of edge vertexes within the node as seen from the triangle. For example, the decoding device may determine, as the reconstructed surface, a surface located in the direction in which the centroid vector faces within the node, as seen from the triangle. For example, the decoding device may determine, as the reconstructed surface, a surface on the opposite side of the center of gravity of edge vertexes between nodes, as seen from the triangle. Furthermore, the decoding device may calculate an offset (Δt) of a reconstructed point from a triangle surface using the positional relationship between the triangle and a point Q generated by ray tracing.

Furthermore, as a method for estimating a reconstructed surface, for example, the decoding device may move the position of the centroid vertex in a direction away from the center of gravity of the edge vertexes. For example, the decoding device may move the position of an edge vertex along the edge, toward a direction away from the center of gravity between nodes. For example, the decoding device may calculate the moving distance of the vertex by using the distance between the vertex and the center of gravity.

When the curved surface is determined to be present, the decoding device may estimate a reconstructed surface of a triangle according to a predetermined method, and generate a point at a position away from the reconstructed surface.

Furthermore, as a method for generating mesh data from a point cloud, a device (for example, the decoding device) generates vertexes from a partial point cloud according to a predetermined method, and generates a series of polygons by connecting vertexes. In this case, the device determines whether a curved surface is present within a certain coordinate section.

When the curved surface is present within the coordinate section, the device may move the position of a centroid vertex in a direction away from the center of gravity of edge vertexes. When the curved surface is present within the coordinate section, the device may move the position of an edge vertex along the edge, toward a direction away from the center of gravity between nodes. For example, the device may calculate the moving distance of the vertex by using the distance between the vertex and the center of gravity.

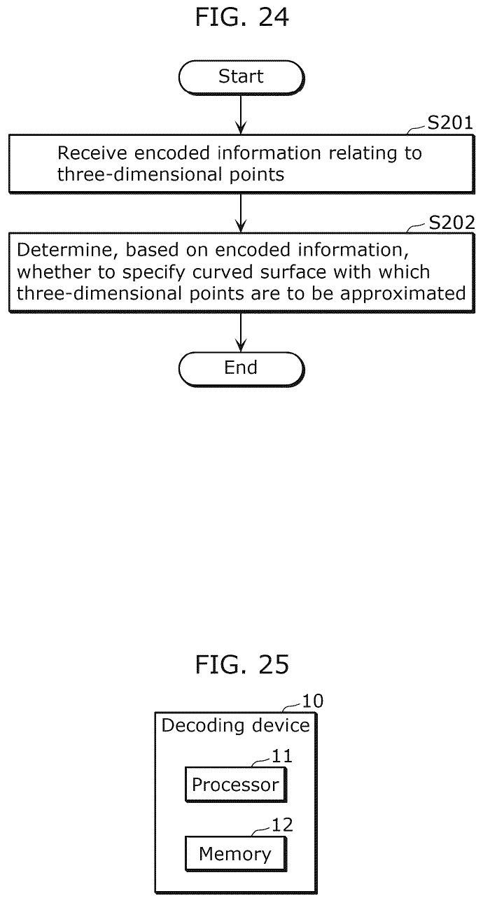

A decoding device (three-dimensional data decoding device) according to the embodiment performs the process illustrated in FIG. 24. The decoding device: receives encoded information relating to three-dimensional points (S201); and determines, based on the encoded information, whether to specify a curved surface with which the three-dimensional points are to be approximated (S202). Accordingly, for example, when reproducibility of the original point cloud can be improved by specifying a curved surface with which the three-dimensional points are to be approximated, the decoding device can specify the curved surface. Therefore, the decoding device can improve the reproducibility of the original point cloud.

For example, in the determining of whether to specify the curved surface (S202), the decoding device determines whether to specify the curved surface with which the three-dimensional points are to be approximated or to specify a plane with which the three-dimensional points are to be approximated. Accordingly, for example, when reproducibility of the original point cloud cannot be improved by specifying a curved surface with which the three-dimensional points are to be approximated, or when reproducibility of the original point cloud can be improved by specifying a plane with which the three-dimensional points are to be approximated, the decoding device can specify the plane. Therefore, since the decoding device can specify the curved surface or the plane in accordance with the original point cloud, the decoding device can improve the reproducibility of the original point cloud.

For example, the curved surface or the plane is provided within a first node of an octree structure of the three-dimensional points. Accordingly, for example, since the decoding device can specify the curved surface or the plane on a per node basis, processing can be appropriately selected according to the properties of the node.

For example, the plane is specified according to a TriSoup scheme or a mesh scheme. Accordingly, since the original point cloud can be approximated with a curved surface without the restriction of only being able to approximate the original point cloud with a plane, such as in a conventional TriSoup scheme or mesh scheme, there are cases where reproducibility of the original point cloud can be improved.

For example, the curved surface protrudes from the plane, away from a center of gravity of edge vertexes, the edge vertexes specifying the plane according to the TriSoup scheme. For example, the curved surface is specified according to information included in the encoded information, the information specifying the plane according to the TriSoup scheme.

For example, an amount of protrusion of the curved surface is greater as the plane is larger. Accordingly, the decoding device can specify a curved surface that can improve the reproducibility of the shape of the original point cloud.

For example, an amount of protrusion at a central portion of the curved surface is greater than an amount of protrusion at a peripheral portion of the curved surface. Accordingly, the decoding device can specify a curved surface that can improve the reproducibility of the shape of the original point cloud.

For example, whether to specify the curved surface is determined based on at least two feature points within a first node of an octree structure of the three-dimensional points, and the at least two feature points are derived from the encoded information. Accordingly, the decoding device can determine whether to specify the curved surface by using information derived from the encoded information.

For example, the at least two feature points are selected from a centroid vertex and a center of gravity of edge vertexes, and the edge vertexes and the centroid vertex are derived according to a TriSoup scheme.

A decoding device: specifies a plane based on encoded information included in a bitstream; and generates at least one three-dimensional point away from the plane. Accordingly, the decoding device can improve reproducibility of the original point cloud compared to when a point is generated only on a plane, for example. For example, it is possible to improve the reproducibility of a curved surface shape which has poor reproducibility using a plane.

For example, the plane is specified according to a TriSoup scheme. For example, the plane and the at least one three-dimensional point are located within a first node of an octree structure of three-dimensional points. Accordingly, the decoding device can perform processing appropriately according to the properties of the node, for example.

For example, the plane is located between the at least one 3D point and a center of gravity of edge vertexes, the edge vertexes specifying the plane according to the TriSoup scheme. Accordingly, reproducibility of the protrusion, and so on, of the original point cloud can be improved by the at least one three-dimensional point. For example, the plane is specified according to a mesh scheme.

A decoding device: moves a first vertex away from a center of gravity of second vertexes, the first vertex and the second vertexes being included among vertexes specified based on encoded information included in a bitstream; specifies a plane or a curved surface by using the first vertex moved and the second vertexes; and generates three-dimensional points on the plane or the curved surface. Accordingly, the decoding device can improve reproducibility of the protrusion, and so on, of the original point cloud by moving the vertex, for example.

FIG. 25 is a block diagram of decoding device 10. For example, decoding device 10 includes processor 11 and memory 12, and processor 11 performs the above-described processes using memory 12.

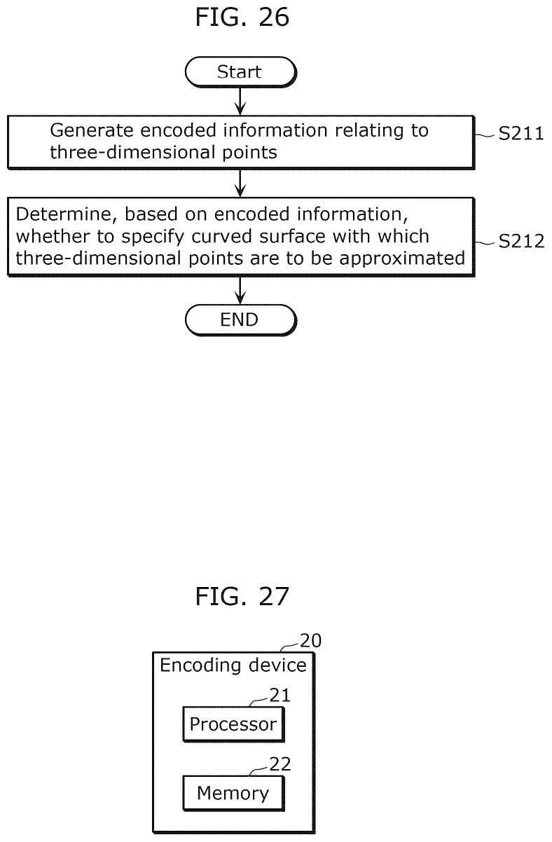

Furthermore, an encoding device according to the embodiment may perform at least part of the process performed by the above-described decoding device. For example, the encoding device (three-dimensional data encoding device) according to the embodiment performs the process illustrated in FIG. 26. The encoding device: generates encoded information relating to three-dimensional points (S211); and determines whether to specify a curved surface with which the three-dimensional points are to be approximated (S212). For example, the encoded information may include information relating to the specifying of a curved surface with which the three-dimensional points are to be approximated. Accordingly, the decoding device can specify the curved surface by specifying a curved surface with which the three-dimensional points are to be approximated, using the information relating to the specifying of the curved surface with which the three-dimensional points are to be approximated. Furthermore, by generating the information in the encoding device, the processing amount of the decoding device can be reduced.

FIG. 27 is a block diagram of encoding device 20. For example, encoding device 20 includes processor 21 and memory 22, and processor 21 performs the above-described processes using memory 22.

An encoding device (three-dimensional data encoding device), a decoding device (three-dimensional data decoding device), and the like, according to embodiments of the present disclosure and variations thereof have been described above, but the present disclosure is not limited to these embodiments, etc.

Note that each of the processors included in the encoding device, the decoding device, and the like, according to the above embodiments is typically implemented as a large-scale integrated (LSI) circuit, which is an integrated circuit (IC). These may take the form of individual chips, or may be partially or entirely packaged into a single chip.

Such IC is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

Moreover, in the above embodiments, the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory.

The present disclosure may also be implemented as an encoding method (three-dimensional data encoding method), a decoding method (three-dimensional data decoding method), or the like executed by the encoding device (three-dimensional data encoding device), the decoding device (three-dimensional data decoding device), and the like.

Furthermore, the present disclosure may be implemented as a program for causing a computer, a processor, or a device to execute the above-described encoding method or decoding method. Furthermore, the present disclosure may be implemented as a bitstream generated by the above-described encoding method. Furthermore, the present disclosure as a recording medium on which the program or the bitstream is recorded. For example, the present disclosure may be implemented as a non-transitory computer-readable recording medium on which the program or the bitstream is recorded.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Also, the processing order of executing the steps shown in the flowcharts is a mere illustration for specifically describing the present disclosure, and thus may be an order other than the shown order. Also, one or more of the steps may be executed simultaneously (in parallel) with another step.

An encoding device, a decoding device, and the like, according to one or more aspects have been described above based on the embodiments, but the present disclosure is not limited to these embodiments. The one or more aspects may thus include forms achieved by making various modifications to the above embodiments that can be conceived by those skilled in the art, as well forms achieved by combining constituent elements in different embodiments, without materially departing from the spirit of the present disclosure.

### INDUSTRIAL APPLICABILITY

The present disclosure is applicable to an encoding device and a decoding device.

1. A decoding method comprising:
receiving encoded information relating to three-dimensional points; and
determining, based on the encoded information, whether to specify a curved surface with which the three-dimensional points are to be approximated.

2. The decoding method according to claim 1, wherein
in the determining, whether to specify the curved surface with which the three-dimensional points are to be approximated or to specify a plane with which the three-dimensional points are to be approximated is determined.

3. The decoding method according to claim 2, wherein
the curved surface or the plane is provided within a first node of an octree structure of the three-dimensional points.

4. The decoding method according to claim 3, wherein
the plane is specified according to a TriSoup scheme or a mesh scheme.

5. The decoding method according to claim 4, wherein
the curved surface protrudes from the plane, away from a center of gravity of edge vertexes, the edge vertexes specifying the plane according to the TriSoup scheme.

6. The decoding method according to claim 5, wherein
the curved surface is specified according to information included in the encoded information, the information specifying the plane according to the TriSoup scheme.

7. The decoding method according to claim 5, wherein
an amount of protrusion of the curved surface is greater as the plane is larger.

8. The decoding method according to claim 5, wherein
an amount of protrusion at a central portion of the curved surface is greater than an amount of the protrusion at a peripheral portion of the curved surface.

9. The decoding method according to claim 1, wherein
whether to specify the curved surface is determined based on at least two feature points within a first node of an octree structure of the three-dimensional points, and
the at least two feature points are derived from the encoded information.

10. The decoding method according to claim 9, wherein
the at least two feature points are selected from a centroid vertex and a center of gravity of edge vertexes, and
the edge vertexes and the centroid vertex are derived according to a TriSoup scheme.

11. A decoding method comprising:
specifying a plane based on encoded information included in a bitstream; and
generating at least one three-dimensional point away from the plane.

12. The decoding method according to claim 11, wherein
the plane is specified according to a TriSoup scheme.

13. The decoding method according to claim 12, wherein
the plane and the at least one three-dimensional point are located within a first node of an octree structure of three-dimensional points.

14. The decoding method according to claim 13, wherein
the plane is located between the at least one 3D point and a center of gravity of edge vertexes, the edge vertexes specifying the plane according to the TriSoup scheme.

15. The decoding method according to claim 11, wherein
the plane is specified according to a mesh scheme.

16. A decoding method comprising:
moving a first vertex away from a center of gravity of second vertexes, the first vertex and the second vertexes being included among vertexes specified based on encoded information included in a bitstream;
specifying a plane or a curved surface by using the first vertex moved and the second vertexes; and
generating three-dimensional points on the plane or the curved surface.
